(19) United States
(12) Patent Application Publication
(10) Pub. No.: US 2010/0218746 A1
(43) Pub. Date: Sep. 2, 2010

(54) BALL-LIFT ELECTROHYDRAULIC VALVE FOR A HYDRAULIC POWER UNIT OF A VARIABLE COMPRESSION RATIO ENGINE

(76) Inventor: Vianney Rabhi, Lyon (FR)

Correspondence Address: YOUNG & THOMPSON, 209 Madison Street, Suite 500, Alexandria, VA, 22314, US

(21) Appl. No.: 12/682,847

(22) PCT Filed: Jul. 3, 2009
(86) PCT No.: PCT/FR2009/000826

§ 371 Date: Apr. 13, 2010

Related U.S. Application Data
(60) Provisional application No. 61/078,047, filed on Jul. 3, 2008.

(30) Foreign Application Priority Data
Jul. 3, 2008 (FR) 08/03759

(51) Int. Cl. F02B 75/04; F16K 31/02

(52) U.S. Cl. 123/48 B; 251/129.15

(57) ABSTRACT

The ball-lift electrohydraulic valve for a hydraulic power unit of a variable compression ratio engine includes:
at least two balls or valve elements each resting on a seat to close off a duct, the first duct connecting a high-pressure circuit of the hydraulic power unit to one of the stages of a multi-stage pressure amplifier that the power unit includes, while the second duct connects a low-pressure circuit of the power unit to the stage, the balls operating like a nonreturn valve element when they are held on their seat by a spring in order to allow the oil contained in the stage to go to the high-pressure circuit but not to return therefrom, and in order to allow the oil originating from the low-pressure circuit to enter the stage but not to leave it again,
and lifting element making it possible to lift the balls or valve elements from their seat and allow the oil both to enter and leave the stage of the multi-stage pressure amplifier.

The present invention relates to a ball-lift electrohydraulic valve for a hydraulic power unit of a variable compression ratio engine.

The electrohydraulic valve according to the present invention comprises:
at least two balls or valve elements each resting on a seat in order for each to close off a duct, the first duct connecting the high-pressure circuit of said hydraulic power unit of said variable compression ratio engine to one of the stages of a multi-stage pressure amplifier that said power unit comprises, while the second duct connects the low-pressure circuit of said power unit to said stage, said balls or valve elements operating like a nonreturn valve element when they are held on their seat by a spring in order to allow the oil contained in said stage to go to the high-pressure circuit of said power unit but not to return therefrom, and in order to allow the oil originating from the low-pressure circuit of said power unit to enter said stage but not to leave it again,
and lifting means making it possible to lift the balls or valve elements from their seat in order to allow said oil both to enter and leave said stage of the multi-stage pressure amplifier.

According to International Patents WO98/51911, WO00/31377, WO03/008783 belonging to the Applicant, various mechanical devices are known for a variable displacement engine.

Note that International Patent WO98/51911 in the name of the Applicant describes a device used to improve the efficiency of internal-combustion piston engines used at variable load and speed by adaptation while running of their effective displacement and/or of their volumetric ratio. This type of engine being known to those skilled in the art as a “variable compression ratio engine”, this name will be used in the following text.

It is known that, according to International Patent WO00/31377 in the name of the Applicant, the mechanical transmission device for a variable compression ratio engine comprises a piston, secured in its lower portion to a transmission member interacting on the one hand with a rolling guidance device, and on the other hand with a gearwheel secured to a connecting rod making it possible to transmit the movement between said piston and said connecting rod.

Note that, according to International Patent WO03/008783 in the name of the Applicant, the mechanical transmission device for a variable compression ratio engine comprises at least one cylinder in which a piston moves which is secured, in its lower portion, to a transmission member interacting on the one hand by means of a small-dimension rack with a rolling guidance device, and on the other hand by means of another large-dimension rack with a gearwheel secured to a connecting rod. Said mechanical transmission device for a variable compression ratio engine also comprises at least one control rack interacting with the gearwheel, means for attaching the piston to the transmission member which offer a clamping prestress, connection means which make it possible to stiffen the teeth of the racks, and means for reinforcing and lightening the structure of the gearwheel.

Note that the minimal operating clearance between the teeth of the large-dimension racks and those of the gearwheel is fixed by the location of bearing surfaces made on said large-dimension racks and said gearwheel.

Note that, according to French Patent Application FR 2 896 539 or International Patent Application WO 2007/085739, the variable compression ratio engine has at least one lifter actuator which allows the rolling surfaces to remain permanently in contact with one another in order to control the acoustic emissions of said engine and to increase the manufacturing tolerances of its crank case.

Note also that, according to Patents WO98/51911 and FR 2 896 539, the vertical position of the control rack of the variable compression ratio engine is controlled by a control actuator which comprises an inlet of pressurized hydraulic fluid provided in order to compensate for possible leaks from said control actuator, and in order to provide a precharge pressure designed to increase the accuracy of maintenance of the vertical-position setpoint of said control actuator by reducing the effects of the compressibility of the oil, and designed to prevent any cavitation phenomenon inside the chambers of said actuator.

Note that the variable compression ratio engine has as many lifter actuators and control actuators as it has cylinders.

As claimed in French Patent Application FR 2 896 539 or International Patent Application WO 2007/085739 in the name of the applicant, the variable compression ratio engine comprises a hydraulic power unit provided on the one hand to supply to its lifter actuator(s) the hydraulic pressure necessary for them to operate and on the other hand to provide its control actuator(s) with the hydraulic pressure necessary to compensate for their possible hydraulic leaks and to increase their accuracy.

It is noted that, according to French Patent Application FR 2 896 539 or International Patent Application WO 2007/085739 in the name of the applicant, the hydraulic pressure provided to the control actuator may also be used to increase the speed of movement of said control actuator during operations designed to increase the volumetric ratio of the variable compression ratio engine. According to this latter variant, said hydraulic pressure is applied to the upper face of the upper rod of the control actuator by means of a chamber created in the cylinder head of said actuator.

It is noted in French Patent Application FR 07/05237 in the name of the applicant that the hydraulic power unit comprises a compressed-air oil-pressure accumulator connected on the one hand to the inlet of a multi-stage pressure amplifier comprising at least one stage and of which the outlet pressure is applied to the lifter actuator(s) of said engine, said outlet pressure being controlled by at least one stage-selection solenoid valve, and connected on the other hand to the control actuator(s) of said engine.

It is seen that the multi-stage pressure amplifier comprises a multi-stage amplifier casing and a multi-stage piston interacting, on the one hand, with at least one transmitter cylinder created in said casing which communicates either with the lubrication circuit of the variable compression ratio engine or with the oil reservoir pressurized by the reserve of pressurized air of said power unit, and on the other hand with a receiver cylinder which communicates hydraulically with the lifter actuators of said engine.

It is observed that the multi-stage pressure amplifier comprises as many stage solenoid valves as stages, said solenoid valves making it possible for each to place their own stage in communication either with the lubrication circuit of the variable compression ratio engine, hereinafter called the “low-pressure circuit”, or with the oil reservoir kept under pressure by the pressurized air reserve of said power unit, hereinafter called the “high-pressure circuit”. It is seen that the stage solenoid valves of the multi-stage pressure amplifier comprise a stage-selection spool making it possible to place one or other of the two inlets of said stage solenoid valves in communication with their outlet, said two inlets not being able to be simultaneously placed in communication with said outlet. It is also seen that said spool is actuated in one direction by placing the first end of said spool in relation with the low-pressure circuit of the hydraulic power unit and in the other direction by means of a return spring which applies a force to the second end of said spool.

As explained in French Patent Application FR 07/05237 in the name of the applicant, the stage solenoid valves of the multi-stage pressure amplifier comprise a small stage-selection solenoid-valve spool moved by the electromagnetic field produced nonsimultaneously by two coils, the first coil being used to push said small spool, while the second is used to pull it. It is noted that said small spool—which can be held in position when it reaches one or other of the ends of its travel by a locking device—makes it possible to place the first end of the stage-selection spool in relation either with the low-pressure circuit of the hydraulic power unit or with the open air.

It is noted that the stage-selection spool interacts with a discharge valve element connecting the transmitter cylinder of its own stage with the high-pressure circuit, said discharge valve element allowing the oil to go from said transmitter cylinder to said circuit when the pressure prevailing in said transmitter cylinder exceeds that of said circuit by a certain value.

It is also noted that the hydraulic power unit comprises at least one high-pressure oil pump driven by the variable compression ratio engine, the oil supply of said hydraulic power unit provided by said oil pump being controlled by a high-pressure oil-pump solenoid valve.

It is noted that the hydraulic power unit also comprises a common resupply manifold making it possible to preselect the destination of the oil originating from the high-pressure oil pump, said manifold comprising one inlet and at least one outlet, and comprising as many resupply solenoid valves as outlets, said resupply solenoid valves comprising an inlet and an outlet.

It is seen that the hydraulic power unit for a variable compression ratio engine also comprises a device for selecting the inlet pressure of the control actuators which comprises a two-position selection spool making it possible to place one or other of its two inlets in communication with its outlet, the first position making it possible to place in pressure communication the circuit connected to the control actuator(s) of said engine with the high-pressure circuit of said power unit, while the second position makes it possible to place in pressure communication the circuit connected to the control actuator(s) of said engine with the low-pressure circuit of said power unit.

According to a particular embodiment, it is explained in French Patent Application FR 07/05237 in the name of the applicant, that the resupply solenoid valves of the common resupply manifold comprise a small resupply spool moved by the electromagnetic field which can be nonsimultaneously generated by two coils, the first coil being used to push said small spool, while the second is used to pull it, said small spool being held in position when it reaches one or the other of the ends of its travel by a locking device.

The ball-lift electrohydraulic valve for a hydraulic power unit of a variable compression ratio engine according to the invention is designed to solve a set of problems associated with the hydraulic power unit for a variable compression ratio engine as described in the various patent applications and patents in the name of the applicant to which reference has just been made and amongst which:
The various spools that the hydraulic power unit comprises and particularly the stage-selection spools and their small stage-selection solenoid-valve spool are used to open and close ducts in which oil travels from the lubrication circuit of the variable compression ratio engine. Since said oil comprises various impurities and particles, it is impossible to produce small clearances between said spools and the cylindrical housing in which they move, such clearances being able to lead to the seizing or jamming of said spools in their said housing when an impurity lodges between said spools and their housing. This impossibility leads to providing considerable operating clearances between said spools and their housing, said clearances causing considerable leakage flow rates and said flow rates causing a considerable power loss which penalizes the total power efficiency of the variable compression ratio engine.
The discharge valve element which connects the transmitter cylinder of each stage of the multi-stage pressure amplifier with the high-pressure circuit of the hydraulic power unit makes said amplifier more complex and increases its price.
Because of the rapid and cyclical variations of position of the multi-stage piston relative to the multi-stage amplifier casing, there is a risk of cavitation that may occur in the transmitter cylinders created in said casing when the stage-selection spool or spools are in an intermediate position during their translation movements and they obstruct both of their inlets for a short moment but simultaneously.
There remains the risk of it being impossible to operate the stage-selection spools because of the low pressure available in the lubrication circuit of the variable compression ratio engine called “low-pressure circuit”, said pressure being used to push said spools via one of their ends while they are returned by a spring which applies a force to their opposite end. This impossibility may occur because of impurities in suspension in the oil forming a brake on the movement of said spool, or else a considerable viscosity of the oil due to the variable compression ratio engine starting in cold weather.
The accuracy required to produce the spools of the hydraulic power unit according to the prior art is considerable and increases the manufacturing cost price of said power unit. Moreover, because of the minimal clearance required between said spools and the cylindrical housing in which they move, this accuracy is not capable of ensuring a perfect seal despite its high cost price.

It is to solve these various problems associated with the hydraulic power unit for a variable compression ratio engine and with the operating mode of said power unit as described in the patent applications and patents in the name of the applicant cited as reference that the ball-lift electrohydraulic valve for a hydraulic power unit of a variable compression ratio engine according to the invention proposes:
the removal of any risk of stopping the operation of the hydraulic power unit due to the possible jamming of its spools when they move in translation in their housing;
the increase in the leakproofing of said power unit, with an increase in the total power efficiency of the variable compression ratio engine caused by reducing the leakage flow rate of pressurized oil, whether the latter originates from the high-pressure circuit or low-pressure circuit;
the reduction and even the elimination of any risk of cavitation in the transmitter cylinders created in the multi-stage amplifier casing;
the simplification of said power unit, notably by removing the discharge valve elements that the multi-stage amplifier comprises and that connect each transmitter cylinder with the high-pressure circuit;
the reduction in the total cost price of said power unit, with parts that are simpler to produce in large volume;
the increase in the general reliability of said power unit.

The ball-lift electrohydraulic valve for a hydraulic power unit of a variable compression ratio engine according to the present invention comprises:
at least two balls or valve elements each resting on a seat in order for each to close off a duct, the first duct connecting a high-pressure circuit (HP) of the hydraulic power unit to one of the stages of a multi-stage pressure amplifier that said power unit comprises, while the second duct connects a low-pressure circuit (LP) of said power unit to said stage, said balls operating like a nonreturn valve element when they are held on their seat by a spring in order to allow the oil contained in said stage to go to the high-pressure circuit (HP) of said power unit but not to return therefrom, and in order to allow the oil originating from the low-pressure circuit (LP) of said power unit to enter said stage but not to leave it again,
and lifting means making it possible to lift the balls or valve elements from their seat in order to allow said oil both to enter and leave said stage of the multi-stage pressure amplifier.

The ball-lift electrohydraulic valve for a hydraulic power unit of a variable compression ratio engine according to the present invention comprises lifting means that consist:
of a lift piston that can move in translation in a lift cylinder situated between the two balls and in the axis which connects one ball to the other ball,
of a cylindrical lifter secured to the lift piston and making it possible to lift one or the other ball from its seat when it moves toward said ball,
and of a lift chamber which is placed in relation, on the one hand, with the high-pressure circuit (HP) of the hydraulic power unit by means of a high-pressure lift solenoid valve and, on the other hand, with the open air by means of a low-pressure lift solenoid valve.

The ball-lift electrohydraulic valve for a hydraulic power unit of a variable compression ratio engine according to the present invention comprises a lift piston which comprises a lift spring making it possible to lift the ball when the lift chamber is connected to the open air by means of the low-pressure lift solenoid valve.

The ball-lift electrohydraulic valve for a hydraulic power unit of a variable compression ratio engine according to the present invention comprises a lift chamber which is placed in relation with the high-pressure circuit (HP) of the hydraulic power unit by means of the high-pressure lift solenoid valve placed on a lift duct connecting the lift chamber to the high-pressure circuit (HP) of said power unit, said solenoid valve being able to open or close said duct.

The ball-lift electrohydraulic valve for a hydraulic power unit of a variable compression ratio engine according to the present invention comprises a high-pressure lift solenoid valve which consists of an electromagnetic suction cup that can lift a high-pressure needle from its seat when an electric voltage is applied to the terminals of a winding of said suction cup, said needle being held under pressure on its seat by a spring.

The ball-lift electrohydraulic valve for a hydraulic power unit of a variable compression ratio engine according to the present invention comprises a lift chamber which is connected to the open air by means of the low-pressure lift solenoid valve placed on an open air connection duct, said solenoid valve being able to open or close said duct.

The ball-lift electrohydraulic valve for a hydraulic power unit of a variable compression ratio engine according to the present invention comprises a low-pressure lift solenoid valve which consists of an electromagnetic suction cup that can lift a low-pressure needle from its seat when an electric voltage is applied to the terminals of a winding of said suction cup, said needle being held under pressure on its seat by a spring.

The ball-lift electrohydraulic valve for a hydraulic power unit of a variable compression ratio engine according to the present invention comprises lifting means which consist of electromagnetic lift actuators each making it possible to lift a ball, said actuators being able to pull or push a cylindrical lifter making it possible to lift said ball when its end comes into contact and then lifts said ball.

The ball-lift electrohydraulic valve for a hydraulic power unit of a variable compression ratio engine according to the present invention comprises an electromechanical actuator which comprises a first electromagnetic suction cup making it possible to lift the ball over a small height, and a second electromagnetic suction cup making it possible to lift said ball over a greater height.

The ball-lift electrohydraulic valve for a hydraulic power unit of a variable compression ratio engine according to the present invention comprises electromechanical lift actuators which consist of at least one electromagnetic suction cup comprising a winding and a cage directly or indirectly attached to the multi-stage pressure amplifier of the hydraulic power unit, said winding being used to create a magnetic field making it possible to attract a metal lifter armature pushing the cylindrical lifter when said winding is traversed by an electric current.

The ball-lift electrohydraulic valve for a hydraulic power unit of a variable compression ratio engine according to the present invention comprises a first electromagnetic suction cup of the electromechanical actuator which consists of a winding and of a metal cage that can be attached to a metal supporting armature, said metal supporting armature being able to move toward the ball but being stopped in the opposite direction by a second suction cup adjustment device directly or indirectly secured to the multi-stage pressure amplifier of the hydraulic power unit.

The ball-lift electrohydraulic valve for a hydraulic power unit of a variable compression ratio engine according to the present invention comprises a second electromagnetic suction cup of the electromechanical actuator which consists of a winding and of a metal cage directly or indirectly attached to the multi-stage pressure amplifier of the hydraulic power unit, said winding being used to create a magnetic field so as to attract the metal supporting armature of the first electromagnetic suction cup when said winding of said second electromagnetic suction cup is traversed by an electric current.

The ball-lift electrohydraulic valve for a hydraulic power unit of a variable compression ratio engine according to the present invention comprises a maximum distance between a metal lifter armature secured to or in contact with the cylindrical lifter on the one hand, and the metal cage of the first electromagnetic suction cup on the other hand, which can be adjusted by means of a first suction cup adjustment device so as to adjust the small lift height of the ball.

The ball-lift electrohydraulic valve for a hydraulic power unit of a variable compression ratio engine according to the present invention comprises a first electromagnetic suction cup adjustment device which consists of a thread making it possible to adjust the position of a lifter stop directly or indirectly secured to the multi-stage pressure amplifier of the hydraulic power unit and on which the metal lifter armature presses relative to the position of the metal cage, said thread being able to be stopped from rotating by locking means.

The ball-lift electrohydraulic valve for a hydraulic power unit of a variable compression ratio engine according to the present invention comprises a maximum distance between the metal supporting armature of the first electromagnetic suction cup and the metal cage of the second electromagnetic suction cup which can be adjusted by means of a second suction cup adjustment device, so as to adjust the large lift height of the ball.

The ball-lift electrohydraulic valve for a hydraulic power unit of a variable compression ratio engine according to the present invention comprises a second suction cup adjustment device which consists of a thread making it possible to adjust the position of the stop of the metal supporting armature relative to the position of the metal cage of the second electromagnetic suction cup, said thread being able to be stopped from rotating by locking means.

The ball-lift electrohydraulic valve for a hydraulic power unit of a variable compression ratio engine according to the present invention comprises a ball-clearance adjustment device consisting of a thread created directly or indirectly in the multi-stage pressure amplifier of the hydraulic power unit and making it possible to adjust the position of the lifter stop relative to that of the seat of the ball.

The ball-lift electrohydraulic valve for a hydraulic power unit of a variable compression ratio engine according to the present invention comprises a ball-clearance adjustment device which consists of a thread created directly or indirectly in the multi-stage pressure amplifier of the hydraulic power unit, making it possible to adjust the position of the lifter stop relative to that of the seat of the ball, said thread being able to be stopped from rotating by locking means.

The ball-lift electrohydraulic valve for a hydraulic power unit of a variable compression ratio engine according to the present invention comprises electromechanical lift actuators which consist of a first electromagnetic suction cup and of a second electromagnetic suction cup securely attached to the casing of the multi-stage pressure amplifier, said first suction cup being able to attract a small-lift free armature coming into contact with the cylindrical lifter, while the second electromagnetic suction cup makes it possible to attract a large-lift armature secured to said lifter.

The ball-lift electrohydraulic valve for a hydraulic power unit of a variable compression ratio engine according to the present invention comprises small-lift and large-lift electromagnetic suction cups which are secured to the casing of the multi-stage pressure amplifier by a cylindrical sheath in which they are housed, said sheath being attached to said casing of the multi-stage pressure amplifier.

The ball-lift electrohydraulic valve for a hydraulic power unit of a variable compression ratio engine according to the present invention comprises a small-lift free armature which comprises a return spring.

The ball-lift electrohydraulic valve for a hydraulic power unit of a variable compression ratio engine according to the present invention comprises a large-lift armature secured to the cylindrical lifter which comprises a return spring.

The ball-lift electrohydraulic valve for a hydraulic power unit of a variable compression ratio engine according to the present invention comprises a small-lift electromagnetic suction cup which comprises adjustment means making it possible to adjust the height of the small lift of the cylindrical lifter.

The ball-lift electrohydraulic valve for a hydraulic power unit of a variable compression ratio engine according to the present invention comprises a large-lift electromagnetic suction cup which comprises adjustment means making it possible to adjust the height of the large lift of the cylindrical lifter.

The ball-lift electrohydraulic valve for a hydraulic power unit of a variable compression ratio engine according to the present invention comprises a cylindrical sheath which comprises adjustment means making it possible to adjust the distance between the cylindrical lifter and the ball when none of the electromagnetic suction cups is supplied with electric current.

The following description with respect to the appended drawings, given as nonlimiting examples, will make it possible to better understand the invention, the features that it proposes and the advantages that it is capable of providing:

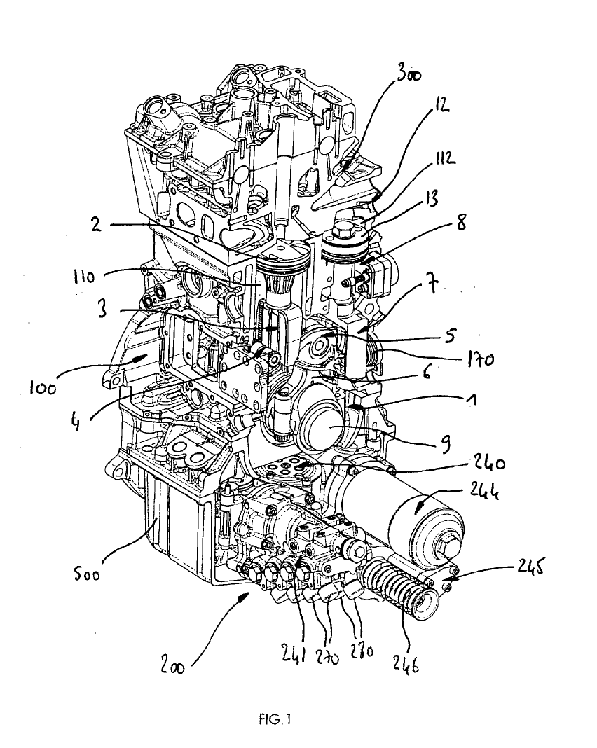

FIG. 1 is a view in perspective illustrating the main components of a variable compression ratio engine and the location of the hydraulic power unit provided with a ball-lift electrohydraulic valve according to the present invention.

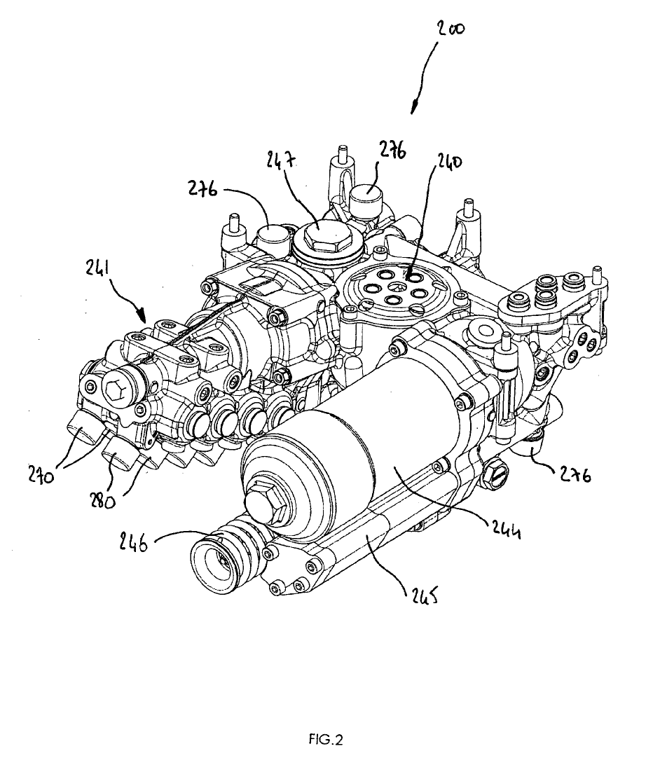

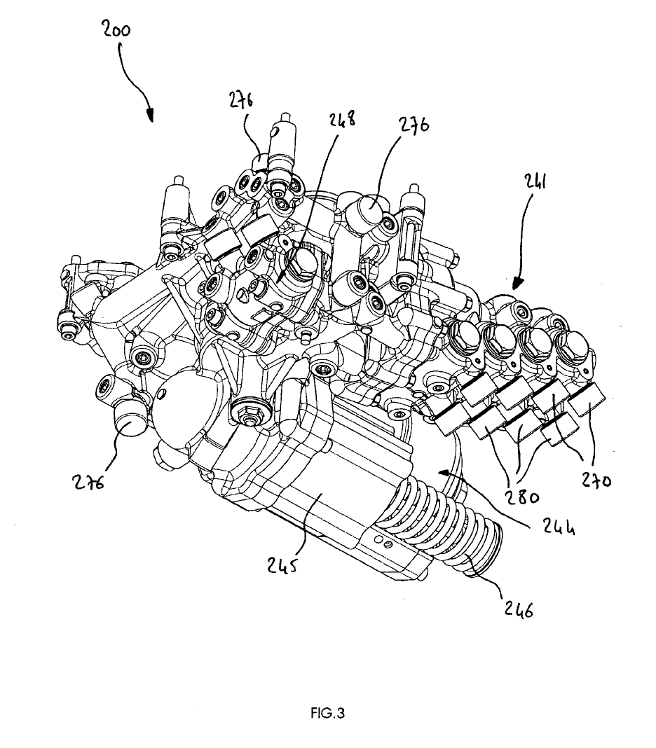

FIGS. 2 and 3 are views in perspective showing the hydraulic power unit and the ball-lift electrohydraulic valve according to the present invention.

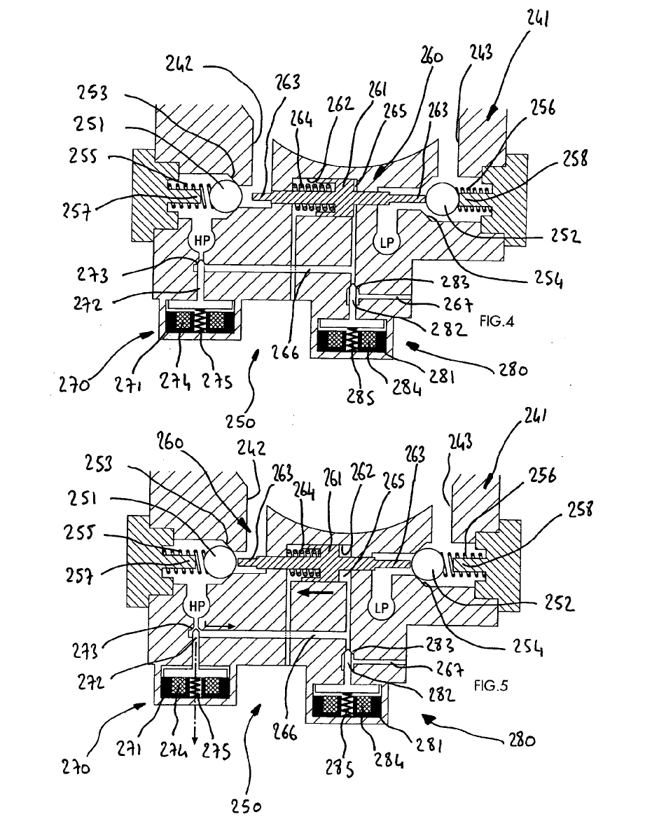

FIGS. 4 to 7 are views showing the various steps of operation of the ball-lift electrohydraulic valve for a hydraulic power unit according to the present invention.

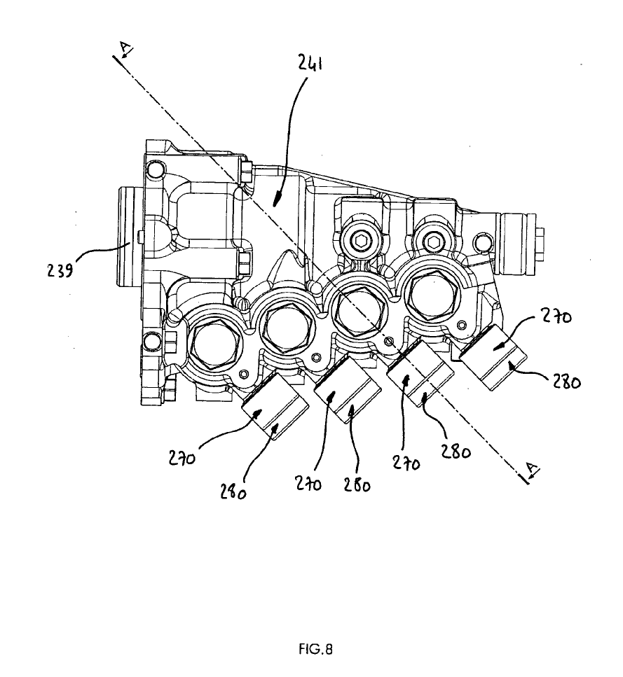

FIG. 8 is a view in perspective illustrating a multi-stage amplifier provided with ball-lift electrohydraulic valves for a hydraulic power unit according to the present invention.

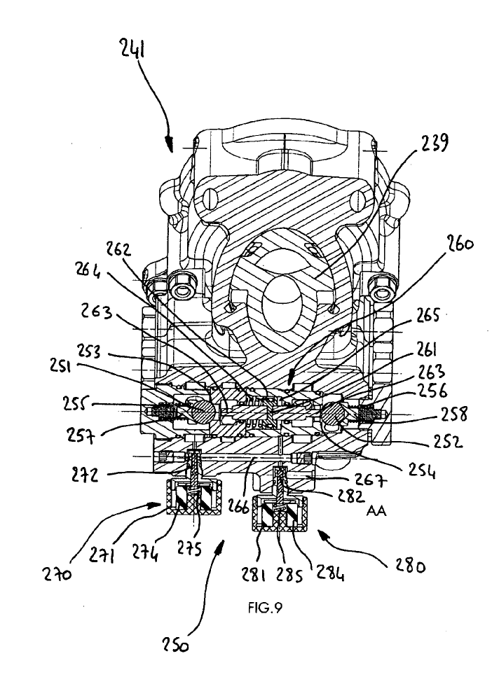

FIG. 9 is a view in section representing the multi-stage amplifier provided with ball-lift electrohydraulic valves for a hydraulic power unit according to the present invention.

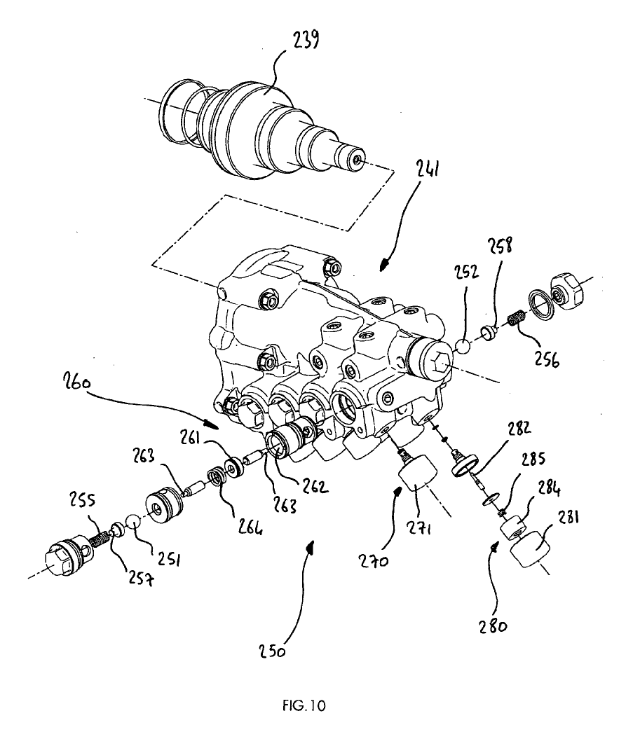

FIG. 10 is an exploded view in perspective illustrating the multi-stage amplifier provided with ball-lift electrohydraulic valves for a hydraulic power unit according to the present invention.

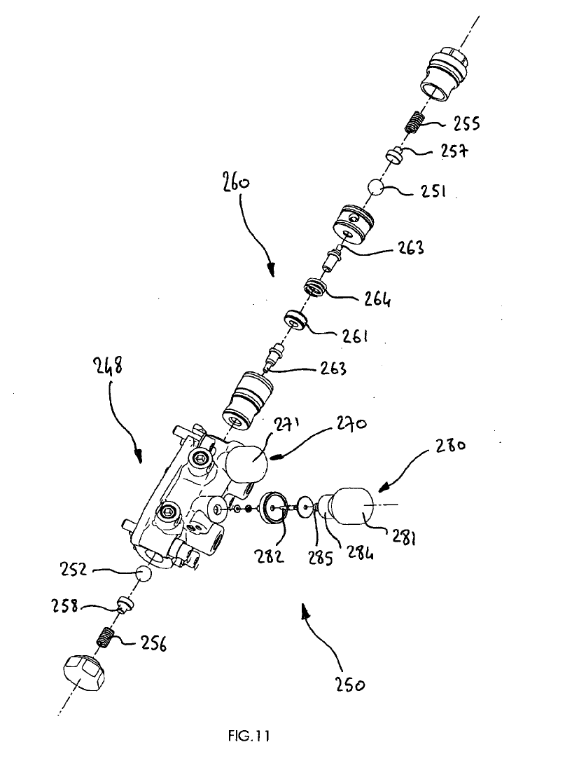

FIG. 11 is an exploded view in perspective representing the ball-lift electrohydraulic valve for a hydraulic power unit according to the present invention applied to a device for selecting the inlet pressure of the control actuators of the variable compression ratio engine.

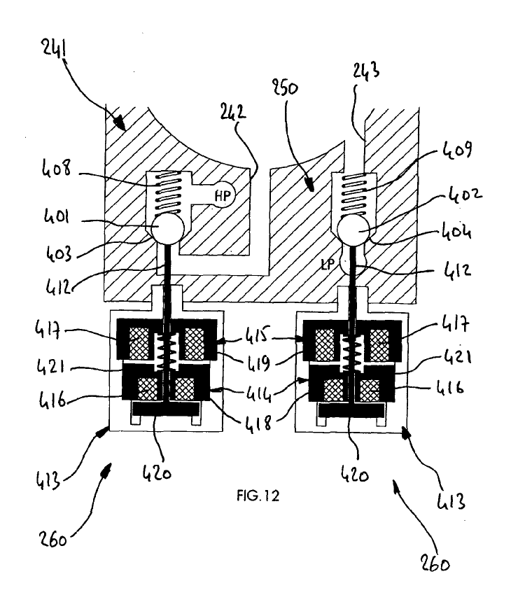

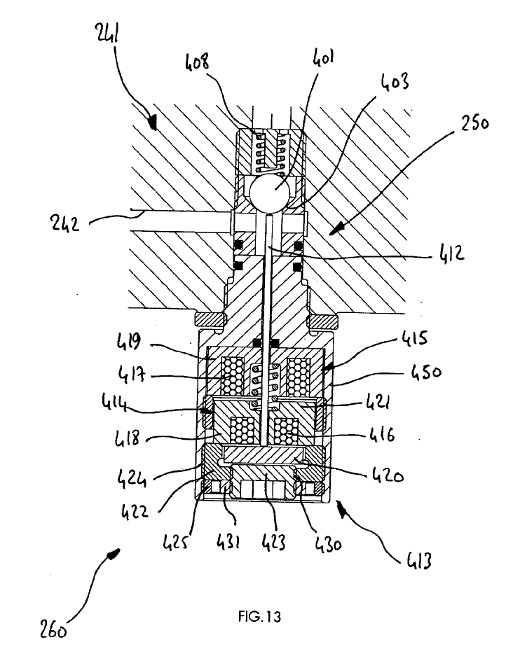

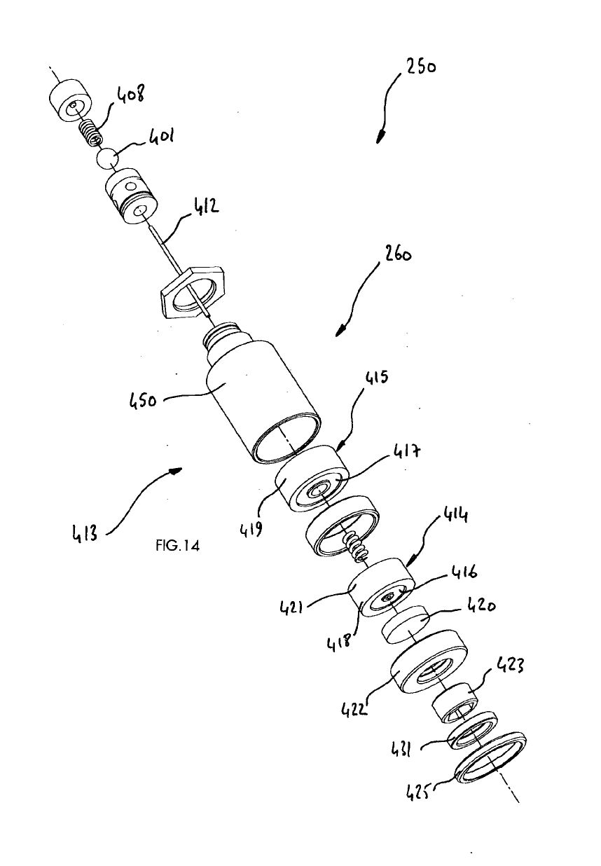

FIGS. 12 to 14 are views representing a first variant embodiment of the ball-lift electrohydraulic valve for a hydraulic power unit according to the present invention.

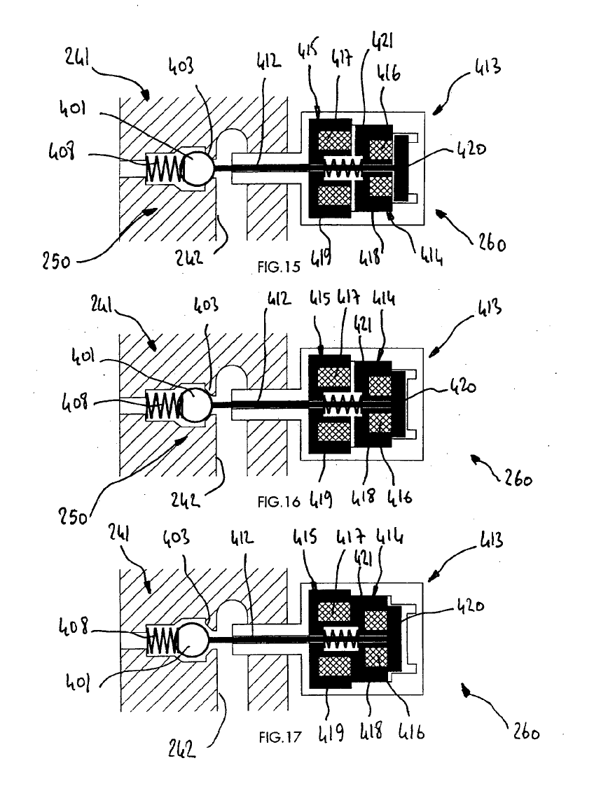

FIGS. 15 to 17 are schematic views showing the operating principle of the first variant embodiment of the ball-lift electrohydraulic valve for a hydraulic power unit according to the present invention.

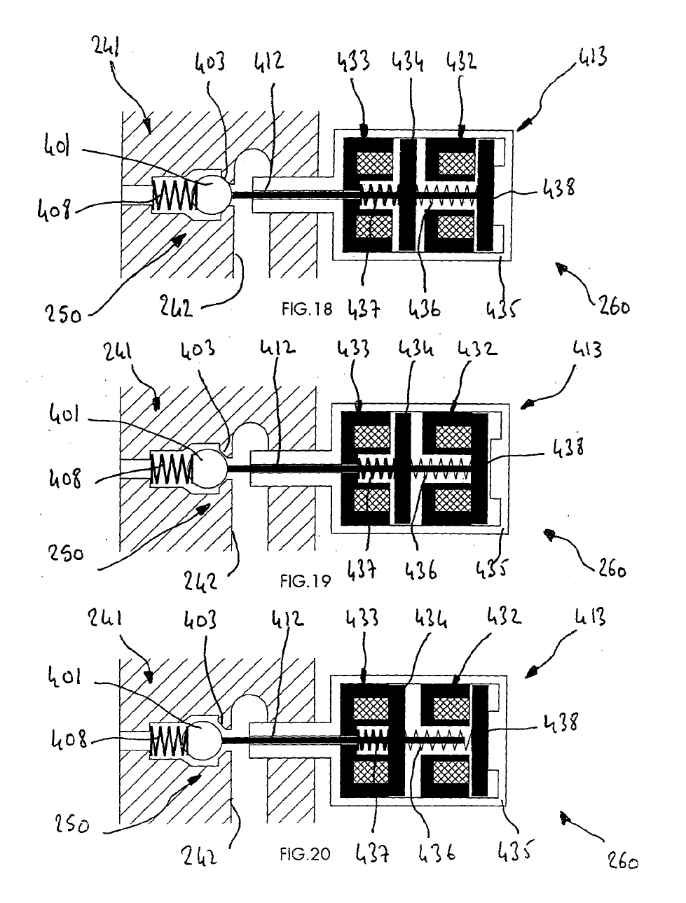

FIGS. 18 to 20 are schematic views showing the operating principle of a second variant embodiment of the ball-lift electrohydraulic valve for a hydraulic power unit according to the present invention.

### DESCRIPTION OF THE INVENTION

FIG. 1 shows an engine block or crank case 100 which comprises at least one cylinder 110 in which a combustion piston 2 moves by means of a transmission device 1 and pressure devices 170 which make it possible to keep in position the main movable components of a variable compression ratio engine.

The mechanical transmission device 1 comprises, in the lower portion of the combustion piston 2, a transmission member or piston rack 3 secured to said piston and interacting, on the one hand, with a rolling guidance device 4, and, on the other hand, with a gearwheel 5.

The gearwheel 5 interacts with a connecting rod 6 connected to a crankshaft 9 in order to transmit the movement between the combustion piston 2 and said crankshaft.

The gearwheel 5 interacts at the opposite end from the transmission member or piston rack 3 with another rack called a control rack 7 the vertical position of which relative to the crank case 100 is controlled by a control device 12 comprising a control actuator 8, the actuator piston 13 of which is guided in an actuator cylinder 112 created in the crank case 100 and closed in its upper portion by an actuator cylinder head 300.

The crank case 100 comprises a hydraulic power unit 200 which consists of various standalone and independent components that can be installed either inside said crank case 100 or at any point in the engine compartment of the vehicle or in the vehicle itself.

According to a preferred embodiment, the various components of the hydraulic power unit 200 may be wholly or partly housed in the sump 500 of the crank case 100.

FIGS. 2 and 3 show a hydraulic power unit 200 for a variable compression ratio engine comprising a set of components including a pressure accumulator 240 for the lubricating oil of the variable compression ratio engine, a multi-stage pressure amplifier 241, a reserve of pressurized air 244, an air pump 245 provided with its spring 246, a circuit separator 247 and an inlet pressure selection device 248 for the control actuators 8 of the variable compression ratio engine.

The above components and other elements allowing the production of the hydraulic power unit 200 are mostly described and detailed in the patent application in France FR 07/05237 belonging to the applicant.

FIGS. 4 to 10 illustrate an exemplary embodiment of a ball-lift electrohydraulic valve 250 for a hydraulic power unit 200 and more particularly for the multi-stage pressure amplifier 241 of the variable compression ratio engine.

The electrohydraulic valve 250 comprises at least two balls 251, 252 or valve elements each resting on a seat 253, 254 in order for each to close off a duct 242, 243 of the multi-stage pressure amplifier 241.

The first duct 242 connects the high-pressure circuit (HP) of the hydraulic power unit 200 of the variable compression ratio engine to one of the stages of the multi-stage pressure amplifier 241, while the second circuit 243 connects the low-pressure circuit (LP) of the hydraulic power unit 200 to said stage.

The balls 251, 252 operate like a nonreturn valve element when they are held on their seat 253, 254 by a spring 255, 256 in order to allow the oil contained in said stage to go to the high-pressure circuit (HP) of said hydraulic power unit 200 but not to return therefrom, and in order to allow the oil originating from the low-pressure circuit (LP) of said power unit to enter said stage but not to leave it.

The balls 251, 252 can be lifted from their seats 253, 254 by lifting means 260 in order to allow the oil both to enter and leave said stage of the multi-stage pressure amplifier 241.

The lifting means 260 can lift only one ball 251, 252 of the electrohydraulic valve 250 at a time, the other ball remaining resting on its seat.

The lifting means 260 consist of a lift piston 261 that can move in translation in a cylinder 262 situated between the two balls 251, 252 and in the axis which connects one ball to the other ball.

The lift piston 261 lifts one or the other ball 251, 252 from its seat 253, 254 when it moves toward said ball and when it pushes said ball by means of a cylindrical lifter 263.

The lift piston 261 can be pushed toward one of the two balls 251 in order to lift said ball from its seat 253 when a hydraulic pressure is applied to said lift piston 261 on its face opposite to the direction of said ball, while said piston 261 is pushed in the other direction by a lift spring 264 in order to lift the other ball 252 from its seat 254 when no hydraulic pressure is applied to said lift piston 261.

The hydraulic pressure is applied to the lift piston 261 by means of a lift chamber 265, said chamber being able to be placed in relation either with the high-pressure circuit (HP) of the hydraulic power unit 200, or with the open air.

The lift chamber 265 is placed in relation with the high-pressure circuit (HP) of the hydraulic power unit 200 by means of a high-pressure lift solenoid valve 270 placed on a lift duct 266 connecting the lift chamber 265 to the high-pressure circuit (HP) of the hydraulic power unit 200, said solenoid valve 270 being able to open or close said duct.

The high-pressure lift solenoid valve 270 consists of an electromagnetic suction cup 271 that can lift a high-pressure needle 272 from its seat 273 when an electric voltage is applied to the terminals of a winding 274 of said suction cup, said needle 272 otherwise being held under pressure on said seat 273 by a spring 275.

The lift chamber 265 is connected with the open air by means of a low-pressure lift solenoid valve 280 placed on an open air connection duct 267, said solenoid valve being able to open or close said duct.

The low-pressure lift solenoid valve 280 consists of an electromagnetic suction cup 281 that can lift a low-pressure needle 282 from its seat 283 when an electric voltage is applied to the terminals of a winding 284 of said suction cup, said needle 282 otherwise being held under pressure on said seat 283 by a spring 285.

According to a particular embodiment of the ball-lift electrohydraulic valve 250 according to the invention, it is noted that, in order to lift the ball 252 placed at the other end from the return spring 264 of the lift piston 261, the lift chamber 265 can be connected either to the open air by placing it in relation with the inner volume of the crank case 100 of the variable compression ratio engine, or placed in relation with the low-pressure circuit (LP) of the hydraulic power unit 200.

The lift piston 261 comprises a seal that can be in one or more portions.

The cylindrical lifters 263 are each furnished with a seal so that the oil contained in the low-pressure circuit (LP) of the hydraulic power unit 200 cannot pass into the lift chamber 265 or vice versa, and so that the oil contained in the high-pressure circuit (HP) cannot pass into the chamber in which the lift spring 264 is housed and vice versa.

The chamber in which the lift spring 264 is housed is furnished with an open air connection duct.

The various chambers in which the balls 251, 252 and their springs 255, 256 are housed and the lift cylinder 262 in which the lift piston 261 is housed are formed of stackable cylindrical elements allowing the whole of the ball-lift electrohydraulic valve 250 according to the invention to be installed in the casing of the multi-stage amplifier 241, said elements being able to have different diameters so as to allow the installation of o-rings which provide the seal between said elements and said casing and being held under longitudinal pressure by a closure plug (FIGS. 9 and 10).

The balls 251, 252 have a maximum-lift stop 257, 258 that can be used as a guide for their spring 255, 256.

FIG. 11 shows the ball-lift electrohydraulic valve 250 for a hydraulic power unit 200 according to the present invention applied to the inlet pressure selection device 248 of the control actuators 8 of the variable compression ratio engine.

FIGS. 12 to 17 show a first variant embodiment of the lifting means 260 of the electrohydraulic valve 250 that consist of electromagnetic lift actuators 413.

The lifting means 260 consist of electromechanical lift actuators 413 which can each lift a ball 401, 402 from its seat 403, 404, said actuators being able to pull or push a cylindrical lifter 412 and said cylindrical lifter 412 being able to lift said ball when its end comes into contact and then lifts said ball.

Therefore, each electromechanical actuator 413 can be housed either directly inside the multi-stage pressure amplifier 241 of the hydraulic power unit 200 or inside a body 450 secured to said multi-stage pressure amplifier 241.

Each electromechanical actuator 413 consists of at least one electromagnetic suction cup 414, 415 comprising a winding 416, 417 and a cage 418, 419.

The winding 416 of the first electromagnetic suction cup 414 is used to create a magnetic field making it possible to attract a metal lifter armature 420 pushing the cylindrical lifter 412 when said winding 416 is traversed by an electric current.

Depending on whether it is pulled or pushed, the cylindrical lifter 412 of each actuator 413 can be wholly or partly housed either in the duct 242, 243 of the multi-stage pressure amplifier 241 or in the high-pressure circuit (HP) or low-pressure circuit (LP) of said multi-stage pressure amplifier 241.

The cylindrical lifter 412 of each actuator 413 is stopped in translation by a lifter stop 423 which is placed in a direction opposite to that allowing said cylindrical lifter 412 to lift the ball 401, 402.

The distance between the lifter stop 423 and the ball 401, 402 can be adjusted by means of a ball-clearance adjustment device in order to make it possible to adjust the clearance between the cylindrical lifter 412 and said ball 401, 402 when said cylindrical lifter 412 and/or the metal lifter armature 420 is in contact with said lifter stop 423.

The ball-clearance adjustment device consists of a thread created directly or indirectly in the multi-stage pressure amplifier 241 of the hydraulic power unit 200 and making it possible to adjust the position of the lifter stop 423 relative to that of the seat 403, 404 of the ball 401, 402.

The thread forming the ball-clearance adjustment device can be stopped from rotating by locking means.

For example, provision is made for the cylindrical lifter 412 to be able to be returned by a spring, not shown, which tends to move it away from the ball 401, 402.

Each electromechanical actuator 413 comprises, on the one hand, a first electromagnetic suction cup 414 making it possible to lift the ball 401, 402 over a small height and, on the other hand, a second electromagnetic suction cup 415 making it possible to lift said ball 401, 402 over a greater height.

The first electromagnetic suction cup 414 consists of a winding 416 and a metal cage 418 which can be attached to a metal supporting armature 421.

The maximum distance between the metal lifter armature 420 secured to or in contact with the cylindrical lifter 412 on the one hand, and the metal cage 418 of the first electromagnetic suction cup 414 on the other hand, can be adjusted by means of a first suction cup adjustment device 423, 430 so as to adjust the small lift height of the ball 401, 402.

The first electromagnetic suction cup adjustment device consists of a thread 430 making it possible to adjust the position of the stop 423 secured directly or indirectly to the multi-stage pressure amplifier 241 of the hydraulic power unit 200 and on which the metal lifter armature 420 rests relative to the position of the metal cage 418, said thread 430 being able to be stopped from rotating by locking means 431.

The metal supporting armature 421 of the first electromagnetic suction cup 414 can move in the direction of the ball 401, 402.

The maximum distance between the metal supporting armature 421 of the first electromagnetic suction cup 414 and the metal cage 419 of the second electromagnetic suction cup 415 can be adjusted by means of a second suction cup adjustment device 422, 424 so as to adjust the large lift height of the ball 401, 402.

The second suction cup adjustment device consists of a thread 424 making it possible to adjust the position of the stop 422 of the metal supporting armature 421 relative to the position of the metal cage 419 of the second electromagnetic suction cup 415, said thread 424 being able to be stopped from rotating by locking means 425.

The winding 416 of said first suction cup 414 is used to create a magnetic field making it possible to attract the metal lifter armature 420 so as to push the cylindrical lifter 412 when said winding 416 is traversed by an electric current.

The second suction cup 415 consists of a winding 417 and a metal cage 419 which can be directly or indirectly attached to the multi-stage pressure amplifier 241 of the hydraulic power unit 200.

The winding 417 of said second suction cup 415 is used to create a magnetic field so as to attract the metal supporting armature 421 of the first electromagnetic suction cup 414 when said winding 417 of said second suction cup 415 is traversed by an electric current.

FIGS. 18 to 20 show a second variant embodiment of the lifting means 260 of the ball-lift electrohydraulic valve 250 which consist of electromagnetic lift actuators 413.

The lifting means 260 consist of electromagnetic lift actuators 413 which can each lift a ball 401, 402 from its seat 403, 404, said actuators being able to pull or push a cylindrical lifter 412 and said cylindrical lifter 412 being able to lift said ball 401, 402 when its end comes into contact and then lifts said ball.

Each electromagnetic lift actuator 413 of the ball-lift electrohydraulic valve 250 consists of a first electromagnetic suction cup 432 and a second electromagnetic suction cup 433 attached to the multi-stage pressure amplifier 241 of the hydraulic power unit 200, said first suction cup 432 being able to attract a small-lift free armature 438 coming into contact with the cylindrical lifter 412, while the second electromagnetic suction cup 433 makes it possible to attract a large-lift armature 434 secured to said lifter.

The small-lift and large-lift electromagnetic suction cups 432, 433 are secured to the multi-stage pressure amplifier 241 by a cylindrical sheath 435 in which they are housed, said sheath 435 being attached to the multi-stage pressure amplifier 241.

The small-lift free armature 438 comprises a return spring 436.

The large-lift armature 434 secured to the cylindrical lifter 412 comprises a return spring 437.

The small-lift electromagnetic suction cup 432 comprises adjustment means, not shown, making it possible to adjust the height of the small-lift of the cylindrical lifter 412.

The large-lift electromagnetic suction cup 433 comprises adjustment means, not shown, making it possible to adjust the height of the large lift of the cylindrical lifter 412.

The cylindrical sheath 435 comprises adjustment means, not shown, making it possible to adjust the distance between the cylindrical lifter 412 and the ball 401, 402 when none of the electromagnetic suction cups 432, 433 is supplied with electric current.

It is noted that, according to a particular embodiment of the hydraulic power unit 200 for a variable compression ratio engine, the needle solenoid valves 270, 280 and their electromagnetic suction cup 271, 281 as proposed for the ball-lift electrohydraulic valve 250 according to the invention may advantageously replace the spool solenoid valves that the resupply manifold of the hydraulic power unit 200 comprises as described in French Patent Application FR 07/05237, in order to benefit from the same functional advantages. In this case, the spool solenoid valves for resupplying the hydraulic power unit 200 become needle resupply solenoid valves 276.

According to this particular embodiment, in addition to being placed on said manifold, said needle resupply solenoid valves 276 can also be placed at any point on the circuit that they are responsible for opening or closing and therefore, at any point on the hydraulic power unit 200.

Note also that this principle may also be used for the high-pressure pump, not shown, which supplies the hydraulic power unit 200, said pump being able to be driven by any one of the camshafts of the variable compression ratio engine.

In this case, the solenoid valve allowing the placement in circuit of said pump can also consist of a needle held on its seat or away from said seat by an electromagnetic suction cup or a solenoid electromagnet.

Note also that, according to a particular embodiment of the hydraulic power unit 200 for a variable compression ratio engine as described in French Patent Application FR 07/05237, the ball-lift electrohydraulic valve 250 according to the invention may be applied without any modification to the inlet pressure selection device 248 of the control actuators 8, said selection device 248 comprising a selection spool which can advantageously be replaced by said electrohydraulic valve 250 (FIG. 11).

### Operation:

According to a particular embodiment and with respect to the figures, the operation of the ball-lift electrohydraulic valve 250 for a hydraulic power unit 200 of a variable compression ratio engine is as follows:

Depending on the speed and the load of the variable compression ratio engine, the pressure applied to the lifter actuators 170 must vary. This is made necessary because of the variations in the force applied to the parts of the movable coupling of said engine, which require a greater or lesser force applied by the lifter actuators 170 in order to limit the acoustic emissions of said engine.

To obtain a variation in the pressure prevailing in the chamber of the lifter actuator(s) 170 of the engine, the various stages of the multi-stage amplifier 241—called the transmitter cylinders—can be subjected independently either to the high pressure of the high-pressure circuit (HP) of the hydraulic power unit 200, or to the low pressure of the low-pressure circuit (LP) of said power unit.

The various stages of said multi-stage amplifier 241 interact to provide the desired pressure for the lifter actuators 170 by adding their pressure forces, the total of these forces being applied via the multi-stage piston 239 to a receiving cylinder, not shown, connected hydraulically to the lifter actuators 170 of the engine.

When, taking account of the operating conditions of the variable compression ratio engine, the management computer ECU of said engine, not shown, must vary the pressure applied to the lifter actuators 170 of said engine, said computer must, depending on the case, vary the pressure applied to one or more stages of the multi-stage amplifier 241 by placing them in relation either with the high-pressure circuit (HP) of the hydraulic power unit 200, or with the low-pressure circuit (LP) of said power unit.

If consideration is given to a single stage of the multi-stage amplifier 241, it is seen in FIGS. 4 to 7 that the ball-lift electrohydraulic valve 250 according to the invention comprises two states.

Note a first state in which the low-pressure circuit (LP) of the hydraulic power unit 200 is in communication with said stage, the lift piston 261 being pushed by its lift spring 264 in order to lift the ball 252 placed on the low-pressure circuit (LP) from its seat 254, so as to allow the oil to flow freely between said stage and said low-pressure circuit (LP), the ball 251 placed on the high-pressure circuit (HP) remaining seated on its seat 253 (FIG. 4).

And a second state in which the high-pressure circuit (HP) of the hydraulic power unit 200 is in communication with said stage, the lift piston 261 being pushed by the pressure prevailing in the high-pressure circuit (HP) of the hydraulic power unit 200 in order to lift the ball 251 placed on the high-pressure circuit (HP) from its seat 253, in order to allow the oil to flow freely between said stage and said high-pressure circuit (HP), the ball 252 placed on the low-pressure circuit (LP) remaining seated on its seat 254, and the lift spring 264 being compressed (FIG. 6).

When the management computer ECU of said engine has to place one of the stages of the multi-stage amplifier 241 in relation with the high-pressure circuit (HP) of the hydraulic power unit 200, said stage up to then being in relation with the low-pressure circuit (LP), it applies an electric voltage to the terminals of the electromagnetic suction cup 271 of the high-pressure lift solenoid valve 270 corresponding to said stage in order to place it in the open position, the low-pressure lift solenoid valve 280 of said stage for its part remaining in the closed position.

Said electromagnetic suction cup 271 of the high-pressure lift solenoid valve 270 will therefore lift the needle 272 of said solenoid valve up to then held under pressure on its seat 273 by a spring 275, allowing the oil contained in the high-pressure circuit (HP) of the hydraulic power unit 200 to enter, via the lift duct 266, the lift chamber 265.

Thus placed under pressure, said lift chamber 265 will communicate its pressure to the lift piston 261 which will, by moving, first rest the ball 252 placed on the low-pressure circuit (LP) on its seat 254 while compressing the lift spring 264, then lift the ball 251 placed on the high-pressure circuit (HP) from its seat 253 while finishing compressing said spring (FIG. 5).

Once the operation is complete, said computer ceases to keep the high-pressure lift solenoid valve 270 open and the pressure in the lift chamber 265 persists so that the stage in question remains in relation with the high-pressure circuit (HP) of the hydraulic power unit 200 for as long as necessary.

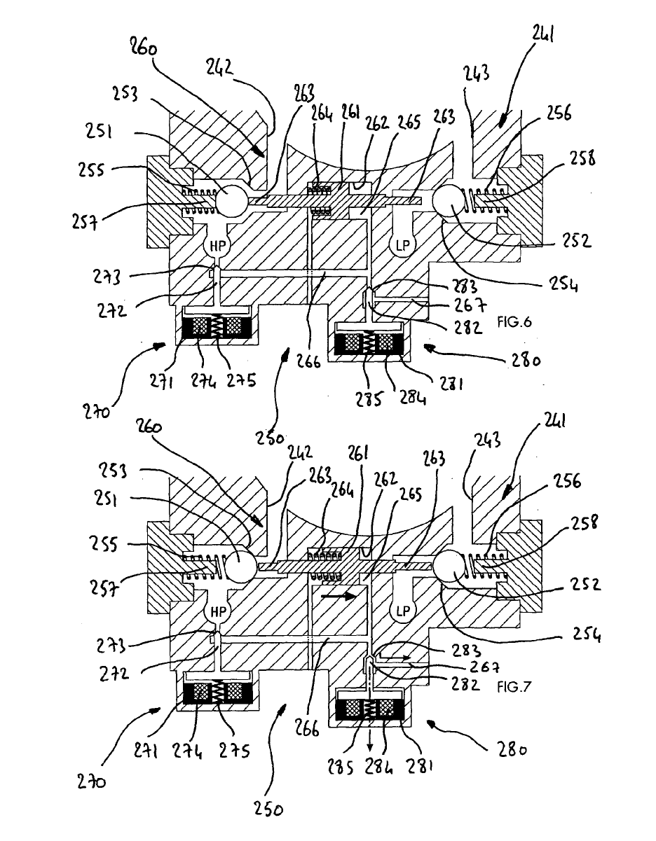

Note in FIGS. 5 and 7 that both balls cannot be opened simultaneously by the lift piston 261.

When the management computer ECU of said engine must place the stage in question of the multi-stage amplifier 241 in relation with the low-pressure circuit (LP) of the hydraulic power unit 200, said stage then being in relation with the high-pressure circuit (HP), it applies an electric voltage to the terminals of the electromagnetic suction cup 281 of the low-pressure lift solenoid valve 280 corresponding to said stage in order to place it in the open position, the high-pressure lift solenoid valve 270 of said stage for its part remaining in the closed position.

Said electromagnetic suction cup 281 of the low-pressure lift solenoid valve 280 therefore lifts the needle 282 of said solenoid valve up to then held under pressure on its seat 283 by a spring 285, allowing the oil contained in the lift chamber 265 to escape from said chamber in order to return to the lubrication oil sump 500 of the variable compression ratio engine (FIG. 7).

Since said lift chamber 265 is thus connected with the open air, the oil that it contains ceases to apply a pressure on the lift piston 261 which then moves under the pressure of the lift spring 264 toward the ball 252 placed on the low-pressure circuit (LP).

The movement of the lift piston 261 has the effect of placing the ball 251 placed on the high-pressure circuit (HP) on its seat 253 while expanding the lift spring 264, and then of lifting the ball 252 placed on the low-pressure circuit (LP) from its seat 254 while completing the expansion of said lift spring 264.

When the maneuver is finished, said computer ceases to hold open the low-pressure lift solenoid valve 280 and the pressure in the lift chamber 265 remains zero so that the stage in question remains in relation with the low-pressure circuit (LP) of the hydraulic power unit 200 for as long as necessary.

It is noted that, during the operations for changing the position of the lift piston 261, both balls 251, 252 are for a short moment simultaneously closed when said piston 261 is approximately in the middle of its travel and neither of the two cylindrical lifters 263 via which it can lift the balls 251, 252 is in contact with said balls (FIGS. 5 and 7).

As the multi-stage piston 239 of the multi-stage amplifier 241 continues to move longitudinally and cyclically because of the operation of the variable compression ratio engine, the volume of the transmitter cylinder of the stage varies.

In the case of the increasing of the volume of said cylinder, the ball 252 placed on the low-pressure circuit (LP) lifts from its seat 254 because the pressure of the low-pressure circuit (LP) of the hydraulic power unit 200 becomes greater than that prevailing in said cylinder which has the effect of allowing the oil necessary to maintain the pressure in the cylinder above the cavitation pressure to pass.

In the case of reducing the volume of said cylinder, the ball 251 placed on the high-pressure circuit (HP) lifts from its seat 253 because the pressure of the high-pressure circuit (HP) of the hydraulic power unit 200 becomes less than that prevailing in said cylinder which has the effect of allowing the oil necessary to maintain the pressure in said cylinder below a threshold which would be damaging for the variable compression ratio engine to pass because of the momentary increase in the pressure applied to its lifter actuators 170 that results therefrom.

Because of their operation similar to that of a nonreturn valve element, the balls 251, 252; 401, 402 of the ball-lift electrohydraulic valve 250 according to the invention which are respectively placed on the high-pressure circuit (HP) and low-pressure circuit (LP) of the hydraulic power unit 200 protect the transmitter cylinder of the stage with which they communicate from any risk of cavitation or excess pressure.

As is noted on reading the description of the operation of the ball-lift electrohydraulic valve 250 according to the invention, the maintenance of a high pressure or of a low pressure in the cylinder of any one of the stages of the multi-stage amplifier 241 of the hydraulic power unit 200 consumes no electric power because the needle 272, 282 of the corresponding lift solenoid valves 270, 280 is kept under pressure on its seat 273, 283 by a spring 275, 285.

However, to compensate for any leakage that may occur at the seal of the lift piston 261 or at the seal of the low-pressure cylindrical lifter 263, or at the seat 273, 283 of any one of the needles 272, 282 of the high-pressure solenoid valve 270 or low-pressure solenoid valve 280, the computer of the variable compression ratio engine may regularly actuate, at a time interval provided as a function of the leakage risks found experimentally, the solenoid valve that has to be actuated to obtain the desired pressure for the stage in question.

This strategy makes it possible to regularly replace the lift piston 261 in the desired position, even if it tends to drift because of leaks.

As shown in FIGS. 15 to 17 and then in FIGS. 18 to 20 illustrating respectively the operation of the ball-lift electrohydraulic valve device 250 according to the first and second variant, the action of the lift piston 261 can be replaced by that of electromagnetic suction cups 414, 415; 432, 433 in order to lift the balls 401, 402 from their seat 403, 404.

It is noted according to these variants that a first electromagnetic suction cup 414, 432 is used to separate said balls 401, 402 from their seat 403, 404 despite a high pressure applied to said balls, while a second electromagnetic suction cup 415, 433 is used to move said balls 401, 402 away from their seat 403, 404 in order to offer a passageway section sufficient for the oil flowing between the hydraulic power unit 200 and the transmitter cylinder of the multi-stage amplifier 241.

It should moreover be understood that the foregoing description has been given only as an example and that it in no way limits the scope of the invention which would not be departed from by replacing the described details of execution with any other equivalent.

1. Ball-lift electrohydraulic valve for a hydraulic power unit (200) of a variable compression ratio engine, characterized in that it comprises:
at least two balls or valve elements (251, 252; 401, 402) each resting on a seat (253, 254; 403, 404) in order for each to close off a duct (242, 243), the first duct (242) connecting a high-pressure circuit (HP) of the hydraulic power unit (200) to one of the stages of a multi-stage pressure amplifier (241) that said power unit comprises, while the second duct (243) connects a low-pressure circuit (LP) of said power unit to said stage, said balls (251, 252; 401, 402) operating like a nonreturn valve element when they are held on their seat (253, 254; 403, 404) by a spring (255, 256; 408, 409) in order to allow the oil contained in said stage to go to the high-pressure circuit (HP) of said power unit but not to return therefrom, and in order to allow the oil originating from the low-pressure circuit (LP) of said power unit to enter said stage but not to leave it again,
and lifting means (260) making it possible to lift the balls or valve elements (251, 252; 401, 402) from their seat (253, 254; 403, 404) in order to allow said oil both to enter and leave said stage of the multi-stage pressure amplifier (241).

2. Ball-lift electrohydraulic valve for a hydraulic power unit of a variable compression ratio engine according to claim 1, characterized in that the lifting means (260) consist:
of a lift piston (261) that can move in translation in a lift cylinder (262) situated between the two balls (251, 252) and in the axis which connects one ball to the other ball,
of a cylindrical lifter (263) secured to the lift piston (261) and making it possible to lift one or the other ball (251, 252) from its seat (253, 254) when it moves toward said ball,
and of a lift chamber (265) which is placed in relation, on the one hand, with the high-pressure circuit (HP) of the hydraulic power unit (200) by means of a high-pressure lift solenoid valve (270) and, on the other hand, with the open air by means of a low-pressure lift solenoid valve (280).

3. Ball-lift electrohydraulic valve for a hydraulic power unit of a variable compression ratio engine according to claim 2, characterized in that the lift piston (261) comprises a lift spring (264) making it possible to lift the ball (252) when the lift chamber (265) is connected to the open air by means of the low-pressure lift solenoid valve (280).

4. Ball-lift electrohydraulic valve for a hydraulic power unit of a variable compression ratio engine according to claim 2, characterized in that the lift chamber (265) is placed in relation with the high-pressure circuit (HP) of the hydraulic power unit (200) by means of the high-pressure lift solenoid valve (270) placed on a lift duct (266) connecting the lift chamber (265) to the high-pressure circuit (HP) of said power unit, said solenoid valve being able to open or close said duct.

5. Ball-lift electrohydraulic valve for a hydraulic power unit of a variable compression ratio engine according to claim 2, characterized in that the high-pressure lift solenoid valve (270) consists of an electromagnetic suction cup (271) that can lift a high-pressure needle (272) from its seat (273) when an electric voltage is applied to the terminals of a winding (274) of said suction cup, said needle (272) being held under pressure on its seat (273) by a spring (275).

6. Ball-lift electrohydraulic valve for a hydraulic power unit of a variable compression ratio engine according to claim 2, characterized in that the lift chamber (265) is connected to the open air by means of the low-pressure lift solenoid valve (280) placed on an open air connection duct (267), said solenoid valve being able to open or close said duct.

7. Ball-lift electrohydraulic valve for a hydraulic power unit of a variable compression ratio engine according to claim 2, characterized in that the low-pressure lift solenoid valve (280) consists of an electromagnetic suction cup (281) that can lift a low-pressure needle (282) from its seat (283) when an electric voltage is applied to the terminals of a winding (284) of said suction cup, said needle (282) being held under pressure on its seat (283) by a spring (285).

8. Ball-lift electrohydraulic valve for a hydraulic power unit of a variable compression ratio engine according to claim 1, characterized in that the lifting means (260) consist of electromechanical lift actuators (413) each making it possible to lift a ball (401, 402), said actuators being able to pull or push a cylindrical lifter (412) making it possible to lift said ball (401, 402) when its end comes into contact and then lifts said ball.

9. Ball-lift electrohydraulic valve for a hydraulic power unit of a variable compression ratio engine according to claim 8, characterized in that the electromechanical actuator (413) comprises a first electromagnetic suction cup (414, 432) making it possible to lift the ball (401, 402) over a small height, and a second electromagnetic suction cup (415, 433) making it possible to lift said ball (401, 402) over a greater height.

10. Ball-lift electrohydraulic valve for a hydraulic power unit of a variable compression ratio engine according to claim 8, characterized in that the electromechanical lift actuators (413) consist of at least one electromagnetic suction cup comprising a winding and a cage directly or indirectly attached to the multi-stage pressure amplifier (241) of the hydraulic power unit (200), said winding being used to create a magnetic field making it possible to attract a metal lifter armature pushing the cylindrical lifter (412) when said winding is traversed by an electric current.

11. Ball-lift electrohydraulic valve for a hydraulic power unit of a variable compression ratio engine according to claim 9, characterized in that the first electromagnetic suction cup (414) of the electromechanical actuator (413) consists of a winding (416) and of a metal cage (418) that can be attached to a metal supporting armature (421), said metal supporting armature (421) being able to move toward the ball (401, 402) but being stopped in the opposite direction by a second suction cup adjustment device (422, 424) directly or indirectly secured to the multi-stage pressure amplifier (241) of the hydraulic power unit (200).

12. Ball-lift electrohydraulic valve for a hydraulic power unit of a variable compression ratio engine according to claim 9, characterized in that the second electromagnetic suction cup (415) of the electromechanical actuator (413) consists of a winding (417) and of a metal cage (419) directly or indirectly attached to the multi-stage pressure amplifier (241) of the hydraulic power unit (200), said winding (417) being used to create a magnetic field so as to attract the metal supporting armature (421) of the first electromagnetic suction cup (414) when said winding (417) of said second electromagnetic suction cup (415) is traversed by an electric current.

13. Ball-lift electrohydraulic valve for a hydraulic power unit of a variable compression ratio engine according to claim 11, characterized in that the maximum distance between a metal lifter armature (420) secured to or in contact with the cylindrical lifter (412) on the one hand, and the metal cage (418) of the first electromagnetic suction cup (414) on the other hand, can be adjusted by means of a first suction cup adjustment device (423, 430) so as to adjust the small lift height of the ball (401, 402).

14. Ball-lift electrohydraulic valve for a hydraulic power unit of a variable compression ratio engine according to claim 13, characterized in that the first electromagnetic suction cup adjustment device consists of a thread (430) making it possible to adjust the position of a lifter stop (423) directly or indirectly secured to the multi-stage pressure amplifier (241) of the hydraulic power unit (200) and on which the metal lifter armature (420) presses relative to the position of the metal cage (418), said thread (430) being able to be stopped from rotating by locking means (431).

15. Ball-lift electrohydraulic valve for a hydraulic power unit of a variable compression ratio engine according to claim 11, characterized in that the maximum distance between the metal supporting armature (421) of the first electromagnetic suction cup (414) and the metal cage (419) of the second electromagnetic suction cup (415) can be adjusted by means of a second suction cup adjustment device (422, 424), so as to adjust the large lift height of the ball (401, 402).

16. Ball-lift electrohydraulic valve for a hydraulic power unit of a variable compression ratio engine according to claim 15, characterized in that the second suction cup adjustment device consists of a thread (424) making it possible to adjust the position of the stop (422) of the metal supporting armature (421) relative to the position of the metal cage (419) of the second electromagnetic suction cup (415), said thread (424) being able to be stopped from rotating by locking means (425).

17. Ball-lift electrohydraulic valve for a hydraulic power unit of a variable compression ratio engine according to claim 8, characterized in that it comprises a ball-clearance adjustment device consisting of a thread created directly or indirectly in the multi-stage pressure amplifier (241) of the hydraulic power unit (200) and making it possible to adjust the position of the lifter stop (423) relative to that of the seat (403, 404) of the ball (401, 402).

18. The ball-lift electrohydraulic valve for a hydraulic power unit of a variable compression ratio engine according to claim 17, characterized in that the ball-clearance adjustment device consists of a thread created directly or indirectly in the multi-stage pressure amplifier (241) of the hydraulic power unit (200), making it possible to adjust the position of the lifter stop (423) relative to that of the seat (403, 404) of the ball (401, 402), said thread being able to be stopped from rotating by locking means.

19. Ball-lift electrohydraulic valve for a hydraulic power unit of a variable compression ratio engine according to claim 9, characterized in that the electromechanical lift actuators (413) consist of a first electromagnetic suction cup (432) and of a second electromagnetic suction cup (433) securely attached to the casing of the multi-stage pressure amplifier (241), said first suction cup (432) being able to attract a small-lift free armature (438) coming into contact with the cylindrical lifter (412), while the second electromagnetic suction cup (433) makes it possible to attract a large-lift armature (434) secured to said lifter.

20. Ball-lift electrohydraulic valve for a hydraulic power unit of a variable compression ratio engine according to claim 19, characterized in that the small-lift electromagnetic suction cup (432) and large-lift electromagnetic suction cup (433) are secured to the casing of the multi-stage pressure amplifier (241) by a cylindrical sheath (435) in which they are housed, said sheath (435) being attached to said casing of the multi-stage pressure amplifier (241).

21. Ball-lift electrohydraulic valve for a hydraulic power unit of a variable compression ratio engine according to claim 19, characterized in that the small-lift free armature (438) comprises a return spring (436).

22. Ball-lift electrohydraulic valve for a hydraulic power unit of a variable compression ratio engine according to claim 19, characterized in that the large-lift armature (434) secured to the cylindrical lifter (412) comprises a return spring (437).

23. Ball-lift electrohydraulic valve for a hydraulic power unit of a variable compression ratio engine according to claim 19, characterized in that the small-lift electromagnetic suction cup (432) comprises adjustment means making it possible to adjust the height of the small lift of the cylindrical lifter (412).

24. Ball-lift electrohydraulic valve for a hydraulic power unit of a variable compression ratio engine according to claim 19, characterized in that the large-lift electromagnetic suction cup (433) comprises adjustment means making it possible to adjust the height of the large lift of the cylindrical lifter (412).

25. Ball-lift electrohydraulic valve for a hydraulic power unit of a variable compression ratio engine according to claim 19, characterized in that the cylindrical sheath (435) comprises adjustment means making it possible to adjust the distance between the cylindrical lifter (412) and the ball (401, 402) when none of the electromagnetic suction cups (432, 433) is supplied with electric current.
